(19) United States
(12) Patent Application Publication
(10) Pub. No.: US 2014/0371357 A1
(43) Pub. Date: Dec. 18, 2014

(54) LIVE PART IN UNATTENDED HOUSEHOLD APPLIANCES

(71) Applicant: DSM IP ASSETS B.V., Heerlen (NL)

(72) Inventors: Johannes Hoekstra, Echt (NL); Josien Krijgsman, Echt (NL); Rui Zhang, Echt (NL)

(21) Appl. No.: 14/368,150

(22) PCT Filed: Dec. 11, 2012
(86) PCT No.: PCT/EP2012/075072

§ 371 Date: Jun. 23, 2014

(30) Foreign Application Priority Data
Dec. 22, 2011 (EP) 11195215.6

(51) Int. Cl. C08K 5/3492; C08K 7/14; C08K 5/5313

(52) U.S. Cl. CPC C08K 5/34922; C08K 5/5313; C08K 7/14
USPC 524/100

(57) ABSTRACT

The invention relates to plastic component for use as a live part in unattended household appliances, complying with IEC 60335 and/or VDE approval for use in unattended household appliances, wherein the plastic component is made from a halogen free flame retardant polymer composition comprising (A) a thermoplastic polyamide polymer; (B) 10-40 wt. % of glass fibers; (C) 10-40 wt. % of melam; and (D) 0-15 wt. % of a halogen free flame retardant; wherein the wt. % are relative to the total weight of the composition; with the proviso that when the polyamide or polyamides in component (A) consist of monomeric units comprising less than 10 mole % of aromatic units, relative to the total molar amount of the monomeric units, the amount of melam (C) is in the range of 15-40 wt. %.

The invention relates to a plastic component for use as a live part in unattended household appliances. The invention also relates to an unattended household appliance, comprising the plastic component as a live part.

IEC 60335 relates to live parts being defined as parts of a non-metallic material supporting metal-to-metal connections that carry a current exceeding 0.2 A during normal operation, or a parts of non-metallic material within a distance of 3 mm of such metal-to-metal connections.

Metal-to-metal connections in the electrical wiring system constitute risk hazards in such unattended household appliances. High current density in combination with potential occurrence of a high resistivity in the metal-to-metal connections can result in local heating which might induce flames in non-metallic parts in contact with or in close vicinity of the metal-to-metal connections. Such burning of non-metallic parts can be the start of bigger disasters. As the risks involved depend on the construction, the components used and the specific uses of the household appliances, standards have been developed which describe test methods as well as performance level requirements tailored for different situations. The European Standard for product performance requirements in unattended appliances is IEC 60335-1.

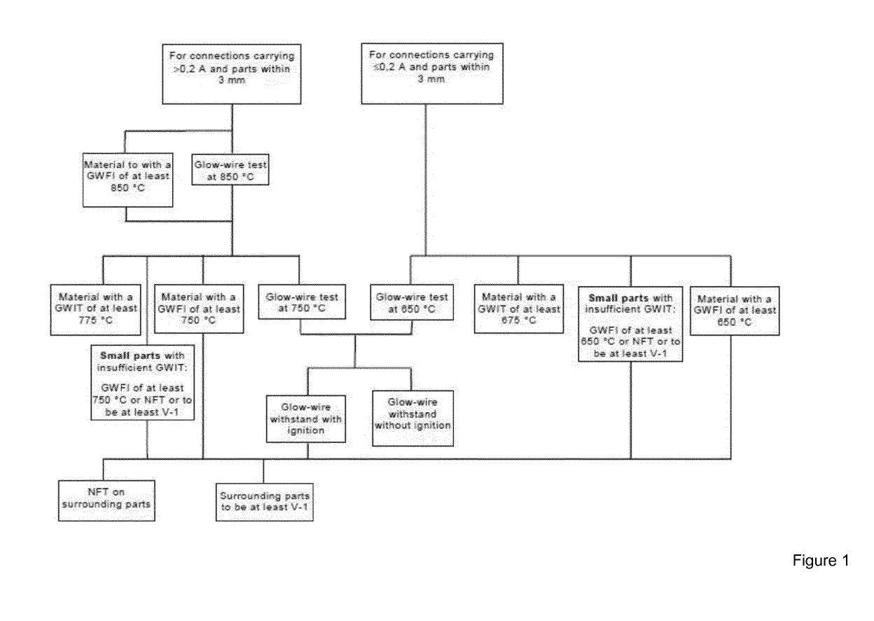

The test sequence for materials and parts used in unattended appliances according to IEC 60335-1 is shown in FIG. 1. According to the standard, the requirements for live parts in combination with a current exceeding 0.2 ampere (A) are as follows: GWFI 850° C. and GWIT 775° C. rating should qualify the material, whereas a GWT 750° C. rating should qualify the end product. In practice, typically always the GWT end product test is done. The tests can be passed with initial ignition of a flame, provided the flame is extinguished within a limited time: 5 seconds for the GWIT rating of at least 775° C. for the material test and 2 seconds for the GWT rating of at least 750° C. for the end-part test. The GWT/GWIT rating is than reported with “n.i.” meaning “no ignition”. In such a case the further surrounding parts have to be at least V-1. In case the GWIT and GWT tests are passed without flame, the rating is reported with “n.f.”, meaning “no flame”. In that case the V-1 requirement for the surrounding parts can be omitted.

Several if not all of these requirements could be fulfilled with several flame retardant plastic compositions comprising a halogen containing flame retardant, optionally combined with synergists like antimony trioxide and other heavy metal components, which materials have been used for such live parts since long.

With the trend towards more environmentally products on one hand and increasing demands in performance level and reducing risk hazards on the other hand, the industry is looking for plastic materials that are not only halogen free, and optionally also free of antimony trioxide and the like, but also for materials that have an even higher GWIT or GWT rating, preferably at least 800° C. or even 850° C. and preferably passing without flame. It has appeared however, that several halogen free flame retardant materials show good flame retardant properties as determined by UL-94-V tests or GWFI tests but do not comply with the GWIT/GWT requirements, or only borderline, or pass with one thickness not at another, and do not comply with more stringent GWIT/GWT requirements. In fact a good flame retardancy level, as demonstrated for example in an UL-94-V test or GWFI test, is no indication for a good GWIT/GWT performance.

The aim of the present invention is therefore to provide plastic components for use as a live part in unattended household appliances, made of halogen free flame retardant materials, which have an improved GWIT/GWT performance.

This aim has been achieved by the plastic part is made from a halogen free flame retardant polymer composition comprising
(A) a thermoplastic polyamide polymer
(B) 10-40 wt. % of glass fibers;
(C) 10-40 wt. % of melam; and
(D) 0-15 wt. % of a halogen free flame retardant;
wherein the wt. % are relative to the total weight of the composition, with the proviso that when the polyamide or polyamides in component (A) consist of monomeric units comprising less than 10 mole % of aromatic units, relative to the total molar amount of the monomeric units, the amount of melam (B) is in the range of 15-40 wt. %.

An effect of the plastic part according to the invention made of said composition is that the GWT/GWIT rating is higher than that of other halogen free flame retardant compositions having similar flame retardancy ratings, or even better flame retardancy ratings. With the plastic part according to the invention a GWIT of 825° C. is rather easily achieved, even at a thickness of 1 mm, whereas a GWIT of 850° C. or even higher is achieved with a large group of the compositions. Analogously a GWT of 800° C. is rather easily achieved, even at a thickness of 1 mm, whereas a GWT of 825° C. or even higher is achieved with a large group of the parts made of the compositions. Another effect is that the GWT/GWIT ratings, particularly the higher ratings are generally passed with no flames.

Because of said properties the plastic part is very suitable to be used as a live part in unattended household appliance. A live part is herein understood to be a part of a non-metallic material supporting metal-to-metal connections that carry a current exceeding 0.2 A during normal operation, or a parts of non-metallic material within a distance of 3 mm of such metal-to-metal connections.

The thermoplastic polyamide polymer (component A) can in principle be any thermoplastic polyamide polymer that is suitable for making plastic parts and, that can be filled with glass fibers in combination with melam. Suitable thermoplastic polyamide polymers are, for example thermoplastic aliphatic polyamide polymers and thermoplastic semi-aromatic polyamide polymers.

Polyamide polymers are either AA-BB type polymers or AB type polymers, or copolymers thereof, comprising monomeric units derived from diamines (referred to as AA units) and diacids (referred to as BB monomeric units), monomeric units respectively lactam monomers or their αω-aminoacid derivatives thereof, (referred to as AB monomeric units), optionally combined with monofunctional monomeric units, which act as chin stopper or end-cappers, and/or multifunctional typically monomeric units, which act as branching agent. Aliphatic polyamide polymers are polyamides based on aliphatic monomers. Semi-aromatic polyamides are polyamides partly based on aliphatic monomers and partly based on aromatic monomers.

Examples of aromatic monomeric units are for example, monomeric units derived from isophthalic acid, terephthalic acid and naphthalene dicarboxylic acid. Suitably, the semi-aromatic polyamide polymer in component (A) comprises the aromatic monomeric units in an amount in the range of 10-50 mole %, for example 20 mole %, 30 mole %, or 50 mole %, relative to the total molar amount of monomeric units in the semi-aromatic polyamide polymer.

The plastic components used for the live parts in household appliances generally have to comply with other requirements as well. For example the parts have to be integrated into larger electrical or electronic assemblies, prior to the actual integration and use in a larger household appliances. Suitably, the integration into larger electrical or electronic assemblies is done by a soldering process, such as a process involving surface mounting technology, also known as SMT process. For that reason the thermoplastic polyamide polymer preferably is a semi-crystalline polymer with a high melting temperature.

Suitable semi-crystalline polyamides are, for example, aliphatic polyamides like polyamide-66 and polyamide-46, and semi-aromatic polyamides like polyamide-6/6T, polyamide-66/6T, polyamide-8,T, polyamide-9,T, polyamide-10,T, polyamide-11,T and polyamide-12,T. Also copolyamides, as well as mixtures of different polyamides can be used. Suitable the mixture of polyamides comprises one or more of the semi-crystalline polyamides mentioned above. Also the copolyamide is based on one or more of the semi-crystalline polyamides mentioned above.

Preferably, component (A) comprises a semi-aromatic polyamide, either alone or in combination with an aliphatic polyamide. The advantage of the presence of the semi-aromatic polyamide is the high GWT and GWIT ratings are obtained at even lower loadings of melam and glass fibres.

In a preferred embodiment, component (A) comprises a semi-aromatic polyamide polymer, and optionally an aliphatic polyamide polymer, wherein the semi-aromatic polyamide polymer comprises aromatic monomeric units in an amount of at least 15 mole %, preferably at least 20 mole %, relative to the total molar amount of monomeric units present in the polyamides of component (A).

Suitably the aromatic monomeric units herein have are derived from isophthalic acid and/or terephthalic acid.

The semi-crystalline polyamide polymer preferably has a meting temperature (Tm) of at least 220° C. More preferably, Tm is at least 240° C., more preferably at least 260° C., even more preferably at least 280° C. or even at least 300° C. With the melting temperature is herein understood the peak melting temperature measured by the method according to ISO-11357-3.2, 2009. The measurement is executed on pre-dried samples, in an N₂ atmosphere with heating and cooling rate of 10° C./min, wherein Tm is measured and calculated for the second heating curve.

The glass fibers (component B) used in the polymer composition can be any type of glass fibers suitable for use in thermoplastic molding compositions. More particular the glass fibers are chopped fibers as generally used in thermoplastic molding compositions used for injection molding. Such chopped glass fibers generally have a fiber length before compounding in the range of 2-6 mm, after compounding in the range of 0.1-1 mm, and after injection molding in the range of 0.05-0.5 mm. In a particular case, the glass fibers suitably have a short length to allow for a higher amount of both melam and the glass fibers, meanwhile resulting in good processing and good GWIT/GWT ratings. In such compositions, the glass fibers suitably have a fiber length in the range of 0.05-0.15 mm.

The glass fibers are suitably present in an amount of 10-40 wt. %. Preferably, the amount of glass fibers is in the range of 15-35 wt. %, even more preferably 20-30 wt. %. Herein the wt. % is relative to the total weight of the composition.

The composition of which the live part according to the invention is made comprises melam (also referred to as component C). Melam is a condensation product of melamine. In combination with the glass fibres, melam provides a high GWIT/GWT rating with no flame already at relative low amounts. On the other hand, melam is easily combined with glass fibers in relative high loadings of each, resulting in even better GWT and GWIT ratings.

Component C is suitably present in an amount of 15-40 wt. %, whereas in case Component (A) comprises a semi-aromatic polyamide, more particular consisting of monomeric units comprising at least 10 mole % of aromatic units, relative to the total molar amount of the monomeric units, the component C is suitably present in an amount of 10-40 wt. %. Preferably the amount of component C is in the range of 15-35 wt. %, more preferably 20-30 wt. %. Herein the wt. % is relative to the total weight of the composition.

The polymer composition may also comprise other components, next to the thermoplastic polyamide polymer (component A), the glass fibers (component B) and melam (component C).

First of all it can be advantageous to include another halogen free flame retardant (component D), to further raise the flame retardant properties of the composition. Suitably, component D comprises a nitrogen based flame retardant (other than component C) and/or a phosphorous flame retardant. Examples of such flame retardants are melamine polyphosphates and metal phoshpinates.

In order to retain the advantageous effect of the composition used in the invention on the GWT/GWIT properties, the amount of component D is kept relatively low. Suitably, component D is present, if any, in an amount of 0-15 wt. %, relative to the total weight of the composition. Preferably the amount is in the range of 0-10 wt. %, more preferably 0-5 wt. %, relative to the total weight of the composition.

The composition used for the plastic live part according to the invention comprises
(A) a thermoplastic aliphatic polyamide polymer and/or a thermoplastic semi-aromatic polyamide polymer;
(B) 10-40 wt. % glass fibers;
(C) 10-40 wt. % of melam, and
(D) 0-15 wt. % of a phosphorous flame retardant and/or a nitrogen based flame retardant,

with the proviso that when the monomeric units in the polyamide or polyamides in component (A) comprise less than 10 mole % of aromatic units, relative to the total molar amount of the monomeric units in the polyamide or polyamides, the amount of melam is in the range of 15-40 wt. %.

Herein, the wt. % of components (A)-(D) are relative to the total weight of the composition. The amounts of the different types of components refer to the total amount of said types of components, not to individual components thereof. For example, if both a thermoplastic aliphatic polyamide polymer and a thermoplastic semi-aromatic polyamide polymer are present, the amount of component (a) refers to the total amount of the thermoplastic polyamide polymer and the thermoplastic polyester polymer. If two phosphorous flame retardants are present, the amount of component (d) refers to the total amount of these two phosphorous flame retardants.

Preferably, the components (B) and (C) are present in a combined amount of at least 35 wt. %, more preferably at least 40 wt. %, still more preferably at least 45 wt. %, relative to the total weight of the composition. Such a higher minimum combined amount results in a higher GWT and GWIT rating, even though in several cases the UL-94-V flame retardancy might even go down.

In a particular embodiment of the invention, the polymer composition comprises 15-35 wt. % of component (C) and 0-10 wt. % of component (D), more particular 15-35 wt. % of component (C) and 0-5 wt. % of component (D).

The polymer composition may comprise further other components, such as polymers other than polyamide and auxiliary additives used in thermoplastic polyamide polymer compositions for electric and electronic components. Such additives can include flame retardant synergists, inorganic fillers, inorganic fibers other than glass fibers, pigments, processing aids, stabilizers, etc.

The inorganic fillers, as they are typically inert with regard to flammability, may be present, if any, in an amount varying over a wide range, for example from 0 to 40 wt. %, suitably in the range of 1-30 wt. %, more particular 5-25 wt. %.

Examples of polymers or polymeric components other than the thermoplastic polyamide polymers, that are suitably comprised in the composition, are for example, impact modifiers and compatibilizers. Such other polymers, if any are suitably present in an amount in the range of 0-20 wt. %, more particular 0.1-10 wt. %, or even 0.5-5 wt. %, relative to the total weight of the composition.

Additives other than the components (A)-(D), inorganic fillers (component E) and other polymers (component F), are typically used to enhance specific properties of the composition and are generally used in relative low amounts each. Examples thereof are auxiliary additives, such as pigments, processing aids, and stabilizers. The total amount of these other additives (together referred to as component F) is suitably in the range of 0-20 wt. %, more particular 0.1-10 wt. %, or even 0.5-5 wt. %, relative to the total weight of the composition. Analogously as above, if the composition comprises as component (G), two pigments and a stabilizer, the amount of component (G) refers to the total amount of these additives.

As an example of the present invention, the composition used for the plastic live part comprises
(A) 30-70 wt. % of a thermoplastic polyamide polymer;
(B) 10-40 wt. % glass fibers;
(C) 10-35 wt. % of melam,
(D) 0-15 wt. % of a phosphorous flame retardant and/or a nitrogen based flame retardant; and
(E) 0-40 wt. % of inorganic fillers,
(F) 0-20 wt. % of other polymers, and
(G) 0-20 wt. % of at least one other additive,

with the proviso that when the monomeric units in the polyamide or polyamides in component (A) comprise less than 10 mole % of aromatic units, relative to the total molar amount of the monomeric units in the polyamide or polyamides, the amount of melam is in the range of 15-35 wt. %.

Herein, the wt. % of components (A-G) are relative to the total weight of the composition.

In a particular embodiment of the present invention, the polymer composition of which the plastic live part is made, consists of the components (A)-(G) in the amounts indicated above. This means that the sum of the amounts of the components (A)-(G) is equal to 100 wt. %.

The plastic part for use as a live part in the present invention and being made of the polymer composition, and particular and preferred embodiments thereof, as described above, may have different wall thicknesses at different locations in the plastic part. Preferably, the plastic part has a wall thickness of around 3 mm, for example in the range of 2-4 mm. With such a wall thickness, better ratings are achieved as it appears to be easier to comply with more stringent GWT/GWIT requirement levels, generally having a GWIT rating of at least 825° C., more particular at least 850° C. or even at least 900° C. and a GWT rating of at least 800° C., more particular at least 825° C. or even at least 875° C. On the other hand, the plastic part may well have a thickness around 1 or around 1.5 mm, for example in the range between 0.5 and 2 mm, as such a part will still comply with high GWT/GWIT ratings, while the rating is still obtained with no flame, thus still performing better than many plastic parts made from other halogen free flame retardant materials. These parts generally have a GWIT rating of at least 825° C., more particular at least 850° C., and a GWT rating of at least 800° C., more particular at least 825° C.

The invention in particular relates to a plastic part or component, or an electrical or electronic product or system comprising said plastic part or component, labeled with a product classification according to IEC 60335 and/or labeled with a GWT rating of at least 800° C. (end part test n.i. limit 2 sec) and/or GWIT rating of at least 825° C. (material test n.i. limit 5 sec) and/or labeled with a VDE approval for use in unattended household appliances.

In order to comply with the said ratings, the plastic component is made from the composition comprising components (A), (B) and (C) in the said amounts as described above.

The labeling may be on the product itself, the packaging or the brochure or any other format of publicity. The packaging so labeled may bear the reference to the product and/or may comprise the product. The brochure or any other format of publicity shall bear or comprise the reference to the product. With the product is herein understood the plastic part, respectively the electrical or electronic product or system comprising said plastic part.

A particular embodiment of the present invention concerns a halogen free plastic component having a GWT rating with a rating temperature of at least 825° C., and/or a GWIT rating with a rating temperature of at least 850° C.

Another particular embodiment of the present invention concerns a halogen free plastic component having a GWT rating with a rating temperature of at least 825° C. and/or a GWIT rating with a rating temperature of at least 850° C., wherein the rating temperature is obtained with “no flame”.

The present invention also relates to the use of a plastic part in an unattended household appliance. The plastic part according to the present invention made of the polymer composition as described above can be any live part in a household appliance, supporting a metal-to-metal connection that carries a current exceeding 0.2 A during normal operation, or a part of within a distance of 3 mm of such a metal-to-metal connection.

The plastic part in the in an unattended household appliance can also be a plastic component in close vicinity of an electrical or electronic heat source, or being a bobbin or capacitor housing.

FIG. 1 Test sequence from IEC 60335-1.

FIG. 1 shows the test sequence for materials and parts used in unattended appliances according to IEC 60335-1.

The invention is further illustrated with the following examples and comparative experiments.

### Test Methods

UL-94-V was measured by the test method according to IEC 60695-11-10.
GWFI was measured by the test method according to IEC 60695-2-12.
GWI was measured by the test method according to IEC 60695-2-13 with the exception that test results were reported for no flame condition (0 seconds flame in stead of 2 or 5 seconds).
GWIT was measured by the test method according to IEC 60695-2-13.

### Materials

The components used in the compositions were the following:

| | |
|---|---|
| PA-I | Polyamide-6,6, aliphatic polyamide, Tm = 265° C.; |
| PA-II | Polyamide 46, aliphatic polyamide, Tm 295° C.; |
| FR-I | melam; |
| FR-II | Exolit OP1230: phosphinate flame retardant ex Clariant; |
| FR-III | Melamine cyanurate; |
| FR-IV | mix (2/1 ratio) of Exolit OP 1230: phosphinate flame |
| | retardant ex Clariant; and Melapur MP200 (melamine |
| | polyphosphate) ex Ciba |
| GF | glass fibres, standard grade for polyamides; initial length |
| | of 4 mm and a diameter of 10 μm; |
| Aux. Add. | Auxiliary additives (mould release and stabilizer) for |
| | polyamide compositions. |

### EXAMPLES AND COMPARATIVE EXPERIMENT

Polymeric materials, based on polyamide, melam, glass fibers, and auxiliary additives, with the compositions according to the invention, as well as compositions used for the comparative experiments were compounded, using standard compounding equipment and processing conditions, and injection molded, using standard injection molding equipment and processing conditions, into test samples with a thickness of respectively 1 mm and 3 mm for the GWFI, GWT and GWIT tests, and 0.75 and 1.5 mm for the UL-94-V tests. The compositions and test results for the comparative experiments are shown in Table 1. The compositions and test results for the examples according to the invention are shown in Table 2.

The results show very solid GWIT and GWT values for the Examples according to the invention at both 1 mm and 3 mm, even though several show a low UL-94-V rating, or even do not classify (NC) and/or a low GWFI rating, whereas the Comparative Experiments show a more borderline performance for at least one of the GWIT and GWT measurements at 1 and 3 mm, despite the generally higher UL-94-V and GWFI ratings.

TABLE 1
Compositions and test results for the comparative experiments A-G.

| | CE-A | CE-B | CE-C | CE-D | CE-E | CE-F | CE-G | CE-H | CE-I | CE-J |
|---|---|---|---|---|---|---|---|---|---|---|
| Composition (wt. %) | | | | | | | | | | |
| PA-I | 64.2 | 69.2 | 74.2 | 79.2 | 74.2 | 79.2 | | 49.2 | | |
| PA-II | | | | | | | 58 | 58 | 49.2 | 58 |
| FR-I | 35 | 30 | 25 | 20 | | | | | 12 | 10 |
| FR-II | | | | | | | 12 | | | 10 |
| FR-III | | | | | 25 | 20 | | | | |
| FR-IV | | | | | | | | 20 | 8 | — |
| GF | | | | | | | 30 | 30 | 30 | 10 |
| Aux. Add. | 0.8 | 0.8 | 0.8 | 0.8 | 0.8 | 0.8 | | 0.8 | 0.8 | 0.8 |
| Test Results | | | | | | | | | | |
| UL-94-V 0.75 mm | V2 | V2 | V2 | V2 | V2 | V2 | V0 | V0 | V0 | V2 |
| UL-94-V 1.5 mm | V2 | V2 | V2 | V2 | V2 | V2 | V0 | V0 | V0 | V2 |
| GWFI 1 mm | 960 | 800 | 900 | 960 | 960 | 960 | | 960 | 960 | 900 |
| GWIT 1 mm | 800 | 800 | 800 | 725 | 800 | 825 | | 775 | 825 | <775 |
| GWT 1 mm 0 s | 775 | 775 | 775 | 725 | 725 | 800 | | 750 | 800 | <750 |
| GWFI 3 mm | 960 | 960 | 960 | 960 | 960 | 960 | 960 | 960 | 960 | 900 |
| GWIT 3 mm | 825 | 800 | 825 | 750 | 850 | 775 | 775 | 775 | 800 | <775 |
| GWT 1 mm 0 s | 800 | 775 | 800 | 725 | 775 | 750 | 750 | 750 | 775 | <750 |

TABLE 2
Compositions and test results for the examples I-XI.

| | EX-I | EX-II | EX-III | EX-IV | EX-V | EX-VI | EX-VII | EX-VIII | EX-IX | EX-X | EX-XI |
|---|---|---|---|---|---|---|---|---|---|---|---|
| Composition (wt. %) | | | | | | | | | | | |
| PA-I | 34.2 | 44.2 | 54.2 | 39.2 | 49.2 | 59.2 | 44.2 | 54.2 | 54.2 | 59.2 | |
| PA-II | | | | | | | | | | | 39.2 |
| FR-I | 35 | 35 | 35 | 30 | 30 | 30 | 25 | 25 | 20 | 20 | 25 |
| FR-II | | | | | | | | | | | 5 |
| GF | 30 | 20 | 10 | 30 | 20 | 10 | 30 | 20 | 25 | 20 | 30 |
| Aux. Add. | 0.8 | 0.8 | 0.8 | 0.8 | 0.8 | 0.8 | 0.8 | 0.8 | 0.8 | 0.8 | 0.8 |
| Test Results | | | | | | | | | | | |
| UL-94-V 0.75 mm | V0 | V2 | V2 | NC | NC | V2 | NC | NC | V2 | V2 | V0 |
| UL-94-V 1.5 mm | V0 | V1 | V2 | NC | NC | V2 | NC | NC | V2 | V2 | V0 |
| GWFI 1 mm | 960 | 960 | 960 | 960 | 930 | 875 | 850 | 875 | 825 | 800 | 960 |
| GWIT 1 mm | 875 | 875 | 850 | 850 | 875 | 825 | 825 | 825 | 825 | 825 | 930 |
| GWT 1 mm 0 s | 850 | 850 | 825 | 825 | 850 | 800 | 800 | 800 | 800 | 800 | 900 |
| GWFI 3 mm | 960 | 960 | 960 | 960 | 960 | 960 | 960 | 960 | 960 | 960 | 960 |
| GWIT 3 mm | 925 | 925 | 925 | 875 | 875 | 825 | 850 | 875 | 875 | 825 | 960 |
| GWT 3 mm 0 s | 900 | 900 | 900 | 850 | 850 | 800 | 825 | 850 | 850 | 800 | 930 |

1. Plastic component for use as a live part in unattended household appliances, complying with IEC 60335 and/or VDE approval for use in unattended household appliances, characterized in that the plastic component is made from a halogen free flame retardant polymer composition comprising
(A) a thermoplastic polyamide polymer
(B) 10-40 wt. % of glass fibers;
(C) 10-40 wt. % of melam; and
(D) 0-15 wt. % of a halogen free flame retardant;
wherein the wt. % are relative to the total weight of the composition;
with the proviso that when the polyamide or polyamides in component (A) consist of monomeric units comprising less than 10 mole % of aromatic units, relative to the total molar amount of the monomeric units, the amount of melam (C) is in the range of 15-40 wt. %.

2. Plastic component according to claim 1, wherein the component has a GWT rating of at least 800° C. and comprises a product with a GWIT rating of at least 825° C.

3. Plastic component according to claim 2, wherein the rating temperature for the GWT is at least 825° C. and/or for the GWIT is at least 850° C.

4. Plastic component according to claim 1, wherein the rating temperature is with “no flame”.

5. Plastic component according to claim 1, wherein the polymer composition comprises 15-35 wt. % of component (C) and 0-10 wt. % of component (D).

6. Plastic component according to claim 1, wherein components (B) and (C) are present in a combined amount of at least 40 wt. %, more preferably at least 45 wt. %, relative to the total weight of the composition.

7. Plastic component according to claim 1, wherein the plastic component is labeled according IEC 60335 and/or labeled with a GWT rating of at least 800° C. and/or a GWIT rating of at least 825° C. and/or with a VDE approval for use in unattended household appliances.

8. Unattended household appliance, comprising a live part according IEC 60335, wherein the live part is a part of a non-metallic material supporting metal-to-metal connections that carry a current exceeding 0.2 A during normal operation, or a part of a non-metallic material within a distance of 3 mm of such metal-to-metal connection, characterised in that the live part is a plastic part made from a halogen free flame retardant polymer composition comprising
(A) a thermoplastic polyamide polymer
(B) 10-40 wt. % of glass fibers;
(C) 10-40 wt. % of melam; and
(D) 0-15 wt. % of a halogen free flame retardant;
wherein the wt. % are relative to the total weight of the composition,
with the proviso that when the polyamide or polyamides in component (A) consist of monomeric units comprising less than 10 mole % of aromatic units, relative to the total molar amount of the monomeric units, the amount of melam (B) is in the range of 15-40 wt. %.

9. Unattended household appliance, comprising a plastic component in close vicinity of an electrical or electronic heat source, or being a bobbin or capacitor housing, wherein the plastic component is made from a halogen free flame retardant polymer composition comprising
(A) a thermoplastic polyamide polymer
(B) 10-40 wt. % of glass fibers;
(C) 10-40 wt. % of melam; and
(D) 0-15 wt. % of a halogen free flame retardant;
wherein the wt. % are relative to the total weight of the composition,
with the proviso that when the polyamide or polyamides in component (A) consist of monomeric units comprising less than 10 mole % of aromatic units, relative to the total molar amount of the monomeric units, the amount of melam (C) is in the range of 15-40 wt. %.

10. Unattended household appliance according to claim 8, wherein the polymer composition comprises 15-35 wt. % of component (C) and 0-10 wt. % of component (D).

11. Unattended household appliance according to claim 8, wherein components (B) and (C) are present in a combined amount of at least 40 wt. %, relative to the total weight of the composition.
